(19) United States
(12) Patent Application Publication
(10) Pub. No.: US 2026/0254375 A1
(43) Pub. Date: Aug. 27, 2026

(54) POWER TOOL INCLUDING SOFT BRAKING TO HARD BRAKING CONTROL

(71) Applicant: MILWAUKEE ELECTRIC TOOL CORPORATION, Brookfield, WI (US)

(72) Inventors: Joshua D. Widder, Grafton, WI (US); Zachary J. Evans, Waukesha, WI (US)

(21) Appl. No.: 19/547,208

(22) Filed: Feb. 23, 2026

Related U.S. Application Data
(60) Provisional application No. 63/762,336, filed on Feb. 24, 2025.

(51) Int. Cl. H02P 3/02; B25F 5/02

(52) U.S. Cl. CPC H02P 3/02; B25F 5/02

(57) ABSTRACT

A power tool including a housing, a motor within the housing, a power switching circuit configured to control power provided from a power source to the motor, and an electronic controller. The electronic controller is connected to the sensor and the power switching circuit. The electronic controller is configured to control the power switching circuit to apply a soft braking force, control a conduction angle and a phase advance angle to increase the soft braking force, control, in response to the conduction angle reaching a maximum conduction angle and the phase advance angle reaching a maximum phase advance angle, the power switching circuit to apply a hard braking force.

### RELATED APPLICATIONS

This application claims the benefit of U.S. Provisional Patent Application No. 63/762,336, filed Feb. 24, 2025, the entire content of which is hereby incorporated by reference.

### FIELD

Embodiments described herein relate to power tools including brushless direct current motors.

### SUMMARY

Power tools can produce energy in the form of angular momentum during operation due to the rotation of a tool or attachment. This energy may continue to drive the tool even after tool operation is no longer desired. As a result, the tool may attempt to brake a motor using switches that are used to drive the motor. However, braking can require large or reinforced electrical components to withstand the strain of braking. Accordingly, some power tools may include a braking system that can quickly brake the tool without straining the electrical components.

Power tools described herein include a housing, a motor within the housing, a power switching circuit configured to control power provided from a power source to the motor, and an electronic controller. The electronic controller is connected to the sensor and the power switching circuit. The electronic controller is configured to control the power switching circuit to apply a soft braking force, control a conduction angle and a phase advance angle to increase the soft braking force, control, in response to the conduction angle reaching a maximum conduction angle and the phase advance angle reaching a maximum phase advance angle, the power switching circuit to apply a hard braking force.

In some aspects, the power switching circuit includes a first high-side switch, a second high-side switch, a third high-side switch, a first low-side switch, a second low-side switch, and a third low-side switch.

In some aspects, to apply the soft braking force, the electronic controller is configured to control two of the first low-side switch, the second low-side switch, and the third low-side switch to be active.

In some aspects, to apply the soft braking force, the electronic controller is configured to control one of the first low-side switch, the second low-side switch, and the third low-side switch to be active.

In some aspects, the maximum conduction angle is 180 degrees.

In some aspects, the maximum conduction angle is 180 degrees to 240 degrees.

In some aspects, the maximum phase advance angle is 60 degrees.

Power tools described herein include a housing, a motor within the housing, a power switching circuit configured to control power provided from a power source to the motor, and an electronic controller. The electronic controller is connected to the sensor and the power switching circuit. The electronic controller is configured to control the power switching circuit to apply a soft braking force, monitor a speed of the motor, control a conduction angle and a phase advance angle to increase the soft braking force, control, in response to the speed of the motor being reduced to a speed threshold value, the power switching circuit to apply a hard braking force.

In some aspects, the power switching circuit includes a first high-side switch, a second high-side switch, a third high-side switch, a first low-side switch, a second low-side switch, and a third low-side switch.

In some aspects, to apply the soft braking force, the electronic controller is configured to control two of the first low-side switch, the second low-side switch, and the third low-side switch to be active.

In some aspects, to apply the soft braking force, the electronic controller is configured to control one of the first low-side switch, the second low-side switch, and the third low-side switch to be active.

In some aspects, the speed threshold value is 3,000 rotations-per-minute to 5,000 rotations-per-minute.

In some aspects, to apply the hard braking force, the electronic controller is configured to control each of the first low-side switch, the second low-side switch, and the third low-side switch to be active.

In some aspects, the power switching circuit to apply the hard braking force before the conduction angle has reached a maximum conduction angle and before the phase advance angle has reached a maximum phase advance angle.

Power tools described herein include a housing, a motor within the housing, a power switching circuit configured to control power provided from a power source to the motor, a sensor configured to measure an operational parameter of the power tool, and an electronic controller. The electronic controller is connected to the sensor and the power switching circuit. The electronic controller is configured to receive a signal from the sensor related to the operational parameter of the power tool, determine, during a startup phase, the operational parameter of the power tool based on the signal from the sensor, calculate a brake adjustment based on the operational parameter, and control, during a braking phase, braking of the motor based on the calculated brake adjustment.

In some aspects, the electronic controller is further configured to control, in response to determining that the operational parameter is below a predetermined threshold, the power switching circuit to brake the motor according to a first braking configuration, and control, in response to determining that the braking parameter is greater than or equal to the predetermined threshold, the power switching circuit to brake the motor according to a second braking configuration.

In some aspects, the operational parameter is one of a temperature, a motor energy, or a motor speed.

In some aspects, the first braking configuration is a reduced torque mode and the second braking configuration is a fast brake mode.

In some aspects, the operational parameter is a startup energy of the motor during the startup phase.

In some aspects, a braking force applied during the braking phase is set based on the operational parameter.

Before any embodiments are explained in detail, it is to be understood that the embodiments are not limited in application to the details of the configurations and arrangements of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Accordingly, in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

Other aspects of the embodiments will become apparent by consideration of the detailed description and accompanying drawings.

### BRIEF DESCRIPTION OF THE DRAWINGS

FIG. 1 is a perspective view of a power tool according to some embodiments.

FIG. 2 is a perspective view of a power tool, according to some embodiments.

FIG. 3 is a control system for the power tool of FIG. 1 and/or FIG. 2, according to some embodiments.

FIG. 4 is a control system for the power tool of FIG. 1 and/or FIG. 2 further illustrating a switching network, according to some embodiments.

FIGS. 5 and 6 illustrate various exemplary switch configurations for controlling a power tool motor, according to some embodiments.

FIG. 7 is a graph illustrating a relationship between braking effort commanded, conduction angle, phase advance angle, and motor speed, according to some embodiments.

FIG. 8 is a process for transitioning between hard and soft braking, according to some embodiments.

FIG. 9 is a graph illustrating a relationship between braking effort commanded, conduction angle, phase advance, and motor speed, according to some embodiments.

FIG. 10 is a block diagram for a control system of a power tool transitioning between different braking modes, according to some embodiments.

FIG. 11A is a graph illustrating a relationship between a speed of a tool, a current of a motor, and a calculated energy of the tool using a light accessory, according to some embodiments.

FIG. 11B is a graph illustrating a relationship between a speed of the tool, a current of a motor, and a calculated energy of the tool using a heavy accessory, according to some embodiments.

FIGS. 12 and 13 illustrate a tool energy during startup and a braking operation, according to some embodiments.

FIG. 14 is a process for controlling a power tool during different operation phases, according to some embodiments.

FIG. 15 illustrates a relationship between a motor output and a speed of the tool during startup and braking operations, according to some embodiments.

FIG. 16 is process for controlling a power tool during different operation and braking phases, according to some embodiments.

FIG. 17 illustrates a tool energy during startup and a braking operation, according to some embodiments.

FIG. 18 illustrates a process for controlling a power tool during startup and a braking operations, according to some embodiments.

FIG. 19 illustrates a tool energy during startup and a braking operation, according to some embodiments.

### DETAILED DESCRIPTION

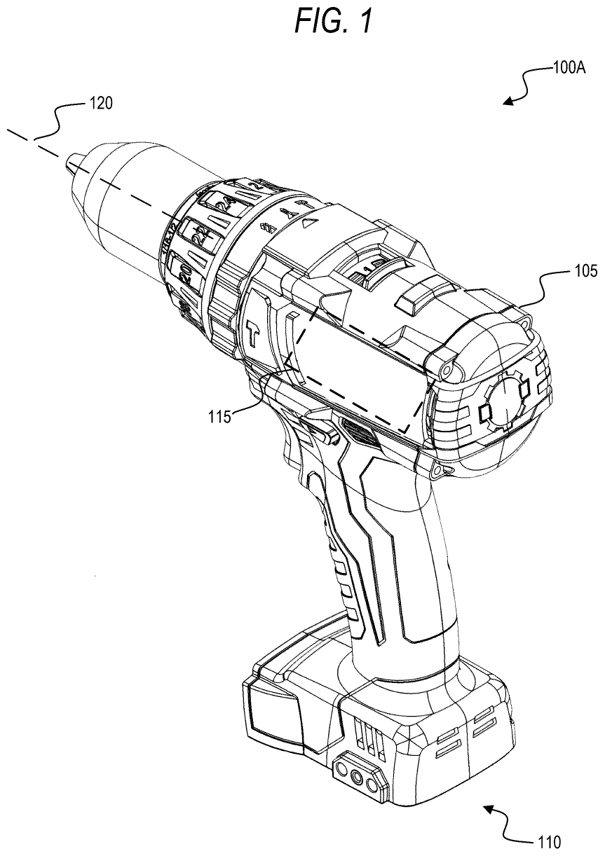

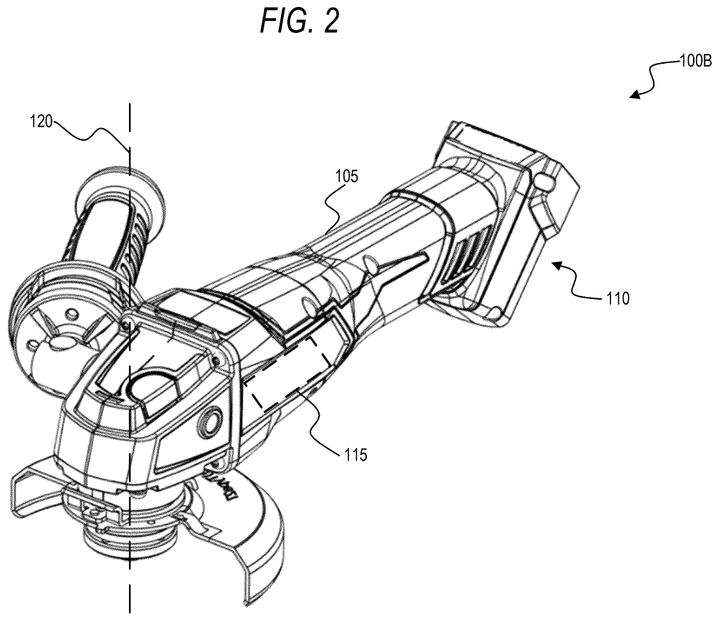

FIGS. 1 and 2 each illustrate an exemplary power tool 100A, 100B. In the embodiment illustrated in FIG. 1, the power tool 100A is a drill/driver. In the embodiment illustrated in FIG. 2, the power tool 100B is a grinder. In some embodiments, the power tool 100 is a different type of power tool (e.g., an impact wrench, a ratchet, a saw, a hammer drill, an impact driver, a rotary hammer, a circular saw etc.). In other embodiments, the power tool may be an outdoor tool (e.g., an edger, a pole saw, a blower, a chainsaw, etc.), a drum machine, etc. Each of the power tools 100A, 100B includes a housing 105 and a battery pack interface 110 for connecting the power tool 100A, 100B to, for example, a battery pack. In some embodiments, the battery pack interface 110 may be configured to connect the power tool 100A, 100B to another device. Each power tool 100A, 100B includes a motor 115 located within the housing 105. The motor 115 includes a rotor, a stator, and a shaft that rotates about a longitudinal axis to produce a rotational output to power an output shaft 120. In some embodiments, the motor 115 is a three-phase permanent magnet synchronous motor (“PMSM”) or a brushless DC (“BLDC”) motor. The output shaft 120, is configured to provide power to a tool holder that may be configured to receive an accessory or other attachment. For example, the power tool 100A may include a chuck that receives a tool bit or drill bit. In another example, the power tool 100B may include an interface couplable to an accessory such as a cutting tool, a grinding disc, a rotary burr, a sanding disc, etc. Various types of accessories may be interchangeably attached to the tool holder and may be designed with different characteristics to perform different types of operations. For example, the accessory may be made of a material and have dimensions suitable for performing a specific type of task. The characteristics of an accessory may affect the performance of the power tool 100 or may impose constraints on operation of the tool. For example, different accessory types may be configured to work at different rotational speeds or applied torques depending on the characteristics of the accessory and the task to be performed. During operation of the power tool 100A, 100B, the motor 115 and the output shaft 120 may be controlled to rotate at a wide range of speeds.

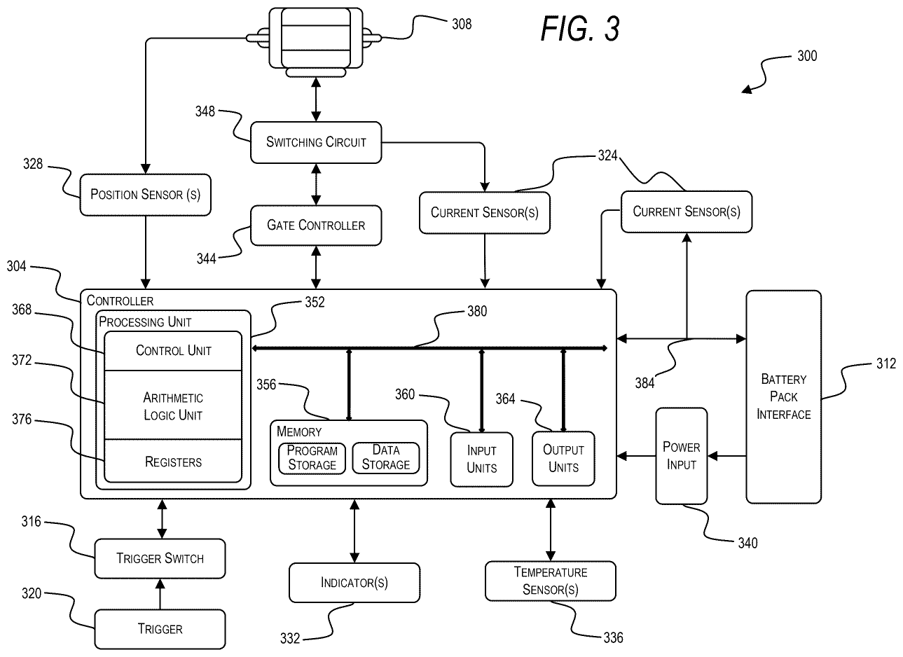

FIG. 3 illustrates a control system 300 for the power tools 100A, 100B. The control system 300 includes a controller 304. The controller 304 is electrically and/or communicatively connected to a one or more modules or components of the power tool 100A, 100B. For example, the illustrated controller 304 is electrically connected to a motor 308 (e.g., motor 115), a battery pack interface 312 (e.g., battery pack interface 110), a trigger switch 316 (connected to a trigger 320), one or more sensors or sensing circuits (e.g., current sensors 324), one or more position sensors 328, one or more indicators 332, one or more temperature sensors 336, a power input module 340, and a gate controller 344 configured to operate a plurality of switches (e.g., FETs) within a switching circuit 348 to control the flow of power between the power source and the motor 308. The position sensor 328 may include Hall effect position sensors, magnetic sensors, inductive sensors, magnetic or inductive sine/cosine encoders, etc. The controller 304 includes combinations of hardware and software that are operable to, among other things, control the operation of the power tool 100A, 100B, monitor the operation of the power tool 100A, 100B, activate the one or more indicators 330 (e.g., an LED), etc.

The controller 304 includes a plurality of electrical and electronic components that provide power, operational control, and protection to the components and modules within the controller 304 and/or the power tool 100. For example, the controller 304 includes, among other things, a processing unit 352 (e.g., a microprocessor, a microcontroller, an electronic processor, an electronic controller, or another suitable programmable device), a memory 356, one or more input units 360, and one or more output units 364. The processing unit 352 includes, among other things, a control unit 368, an arithmetic logic unit (“ALU”) 372, and a plurality of registers 376, and is implemented using a known computer architecture (e.g., a modified Harvard architecture, a von Neumann architecture, etc.). The processing unit 352, the memory 356, the input units 360, and the output units 364, as well as the various modules or circuits connected to the controller 304 are connected, such as, for example, by one or more control and/or data buses (e.g., common bus 380). The use of one or more control and/or data buses for the interconnection between and communication among the various modules, circuits, and components would be known to a person skilled in the art in view of the embodiments described herein.

The memory 356 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 352 is connected to the memory 356 and executes software instructions that are capable of being stored in a RAM of the memory 356 (e.g., during execution), a ROM of the memory 356 (e.g., on a generally permanent basis), or another non-transitory computer readable medium such as another memory or a disc. Software included in the implementation of the power tool 100 can be stored in the memory 356 of the controller 304. The software includes, for example, firmware, one or more applications, program data, filters, rules, one or more program modules, and other executable instructions. The controller 304 is configured to retrieve from the memory 356 and execute, among other things, instructions related to the control processes and methods described herein. In other constructions, the controller 304 includes additional, fewer, or different components.

The battery pack interface 312 includes a combination of mechanical components (e.g., rails, grooves, latches, etc.) and electrical components (e.g., one or more terminals) configured to and operable for interfacing (e.g., mechanically, electrically, and communicatively connecting) the power tool 100 with a battery pack. For example, power provided by the battery pack to the power tool 100 is provided through the battery pack interface 312 to the power input module 340. The power input module 340 includes combinations of active and passive components to regulate or control the power received from the battery pack prior to power being provided to the controller 304. The battery pack interface 312 also supplies power to the switching circuit to provide power to the motor 308.

The indicators 330 include, for example, one or more light-emitting diodes (“LEDs”). The indicators 330 can be configured to display conditions of, or information associated with, the power tool 100. For example, the indicators 330 are configured to indicate measured electrical characteristics of the power tool 100, the status of the power tool 100, etc. In some embodiments the control system 300 may include a user input module operably coupled to the controller 304 to, for example, select a forward mode of operation or a reverse mode of operation, a torque and/or speed setting for the power tool 100 (e.g., using torque and/or speed switches), etc. In some embodiments, the user input module includes a combination of digital and analog input or output devices required to achieve a desired level of operation for the power tool 100, such as one or more knobs, one or more dials, one or more switches, one or more buttons, etc.

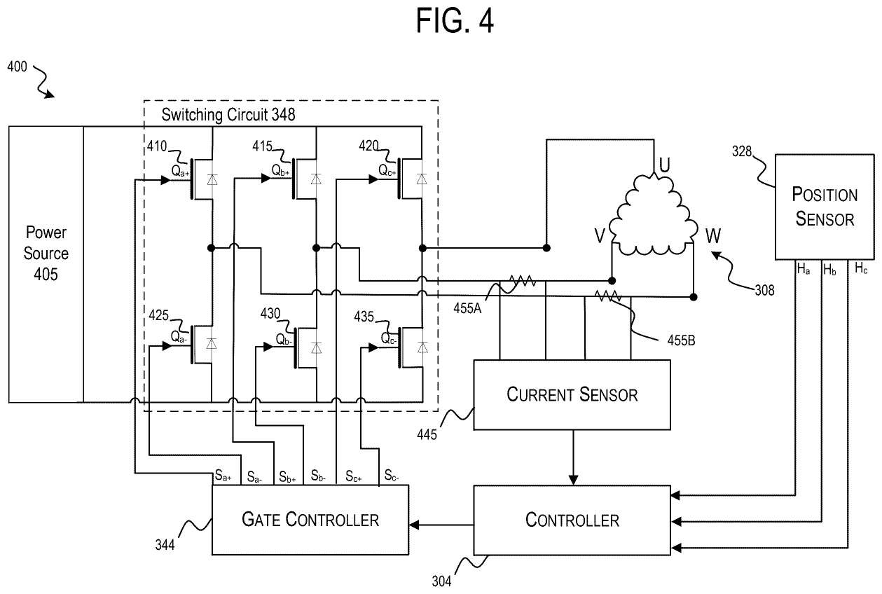

FIG. 4 illustrates a more detailed motor control system 400 for the power tool 100A, 100B. The control system 400 is a schematic of the control system 300 and accordingly may include elements described in the control system 300 but not illustrated. In the illustrated example of FIG. 4, the motor 308 is a three-phase motor having a U-phase, a V-phase, and a W-phase. The switching circuit 348 includes a plurality of electronic switches (e.g., MOSFETS including a body diode formed between the drain and the source terminals) 410, 415, 420, 425, 430, 435 coupled to the phases of the motor 308. In the illustrated embodiment, the switching circuit 348 includes a plurality of high-side switches 410, 415, 420 and a plurality of low-side switches 425, 430, 435. The plurality of high-side switches 410, 415, 420 are provided on the positive side of the current path between the U, V, and W phases of the motor 308 and a power source 405 (e.g., a battery pack coupled via the battery pack interface 312). The plurality of low-side switches 425, 430, 435 are provided on the negative side of the current path between the U, V, and W phases of the motor 308 and the power source 405.

The control system 400 further includes one or more current sensors 445 configured to measure the current provided to the motor 308. In the embodiment illustrated in FIG. 4, the current sensor 445 is coupled to two shunt resistors 455A, 455B disposed along two phases of the motor 308. In other embodiments, additional or fewer resistors (e.g., one or three) may be used to measure the current drawn by the motor 308. In other embodiments, other current sensors may be implemented including Hall effect sensors, fluxgate sensors, and/or current transformers.

Each of the plurality of switches within the switching circuit 348 is operable through the gate controller 344 to control the flow of power to each phase of the motor 308. Additionally, the timing of the switching circuit 348 can be adjusted to allow for larger power outputs and/or faster rotating speeds by adjusting the conduction angle and/or phase advance angle of the motor. Generally, a conduction angle applied to a BLDC motor (e.g., the motor 115, 308) is set to a default value (e.g., approximately 105°, approximately 120°, between 90° and 120°, etc.). However, the conduction angle for a given phase may be increased up to a maximum value, such as 180°, 235°, 240°, any value between 180° and 240°, etc. Increasing the conduction angle allows for more current to flow through the motor windings for a longer duration, which can result in higher torque production. Generally, a phase advance applied to a BLDC motor (e.g., the motor 115, 308) aligns the current waveform with the motor's back EMF, which may weaken the magnetic field of the motor. As a result, a phase advance applied to a BLDC motor 500 may reduce the motor's torque output and may allow the motor 500 to operate at higher speeds with a reduced torque output.

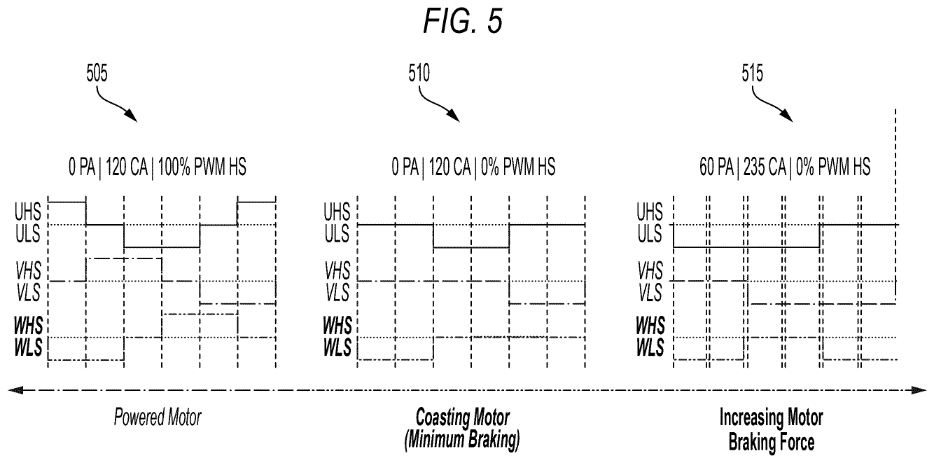

FIGS. 5 and 6 illustrate various exemplary switch configurations (or motor commutations) for operating and braking a power tool such that a range of braking force is generated by a motor (such as motors 115, 308). Generally, braking occurs when the motor provides force against the direction of the motor's rotation. FIGS. 5 and 6 provide examples of short circuit braking, whereby the current induced by the rotation of the motor is controlled to flow in the direction opposite to the rotational direction of the motor. Short circuit braking can occur using any number of the low side switches, with the activation of more switches resulting in a greater braking force. It should be noted, however, that large braking forces are not always desirable as a large spike in current resulting from the fast-moving motor may damage components in the drive circuit, such as sensors disposed on the power bus or fuses configured to prevent a power surge. Hereafter, this disclosure refers to three low side switches being short circuited as “hard braking” and one or two low side switches being short circuited as “soft braking.”

FIG. 5 illustrates an exemplary motor switching arrangement as the power tool 100A, 100B begins braking after a trigger release. As shown in graph 505, the motor is commutated such that the high-side switches (such as high-side switches 410, 415, 420) are on (i.e., have a PWM duty cycle of 100%) and to allow current to flow across each motor phase in subsequent order to drive rotation in the motor. After the trigger is released or another stop signal is provided, the motor is controlled to coast and a minimum amount of braking is applied. As shown in graph 510, when the motor is controlled to coast, the high-side switches are turned off (i.e. PWM duty cycle of 0%), and one low-side switch is commutated with a conduction angle of 120 degrees, and with 0 degrees of phase advance angle. Additionally, only one motor phase is short-circuited at a time. After coasting for a period, the motor can then be controlled to apply an increasing amount of braking force. To increase the amount of braking force, the conduction angle and the phase advance of the braking motor phases are both periodically increased until a maximum conduction angle of 240 degrees and a maximum phase advance of 60 degrees is reached. Graph 515 illustrates a motor commutation having a conduction angle of 235 degrees and a phase advance of 60 degrees. Due to the magnitude of the conduction angle and phase advance, two phases of the motor are short circuited in graph 515. It will be appreciated that for other systems different maximum conduction angle and phase advance values will be used. In some embodiments, a phase advance angle of greater than 60 degrees can be used to enable regenerative braking. In such embodiments, the conduction angle can remain fixed (e.g., at the maximum conduction angle).

FIG. 6 illustrates another embodiment of braking by adjusting the motor commutation. Similar to FIG. 5, after a stop signal is provided, the motor is controlled to coast according to graph 510. After coasting, the brake force is increased by increasing the phase advance from 0 to 60 degrees without changing the conduction angle. After reaching a 60 degrees phase advance, the conduction angle is then increased independently from the phase advance up to 240 degrees. As shown in graph 600, an intermediate braking force point in the commutation is controlled at a 60-degree phase advance and a 180-degree conduction angle. It will be appreciated that because phase advance is increased before the conduction angle, the motor's torque output is decreased before the braking process increases the amount of braking force applied to the motor. Accordingly, the braking process is gentler to the components of the drive circuit. In some embodiments, the conduction angle and the phase advance angle are increased simultaneously.

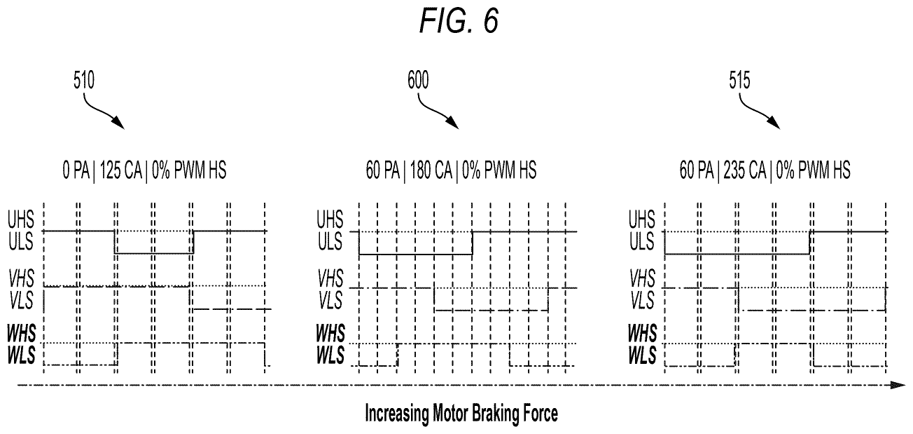

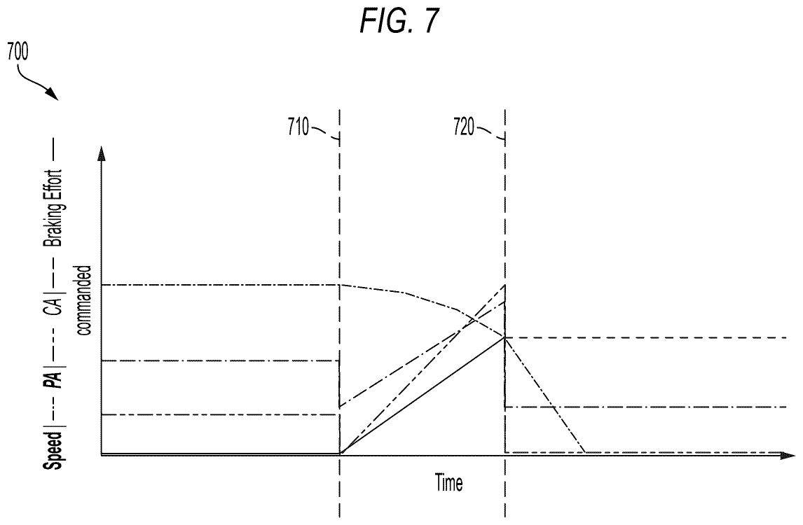

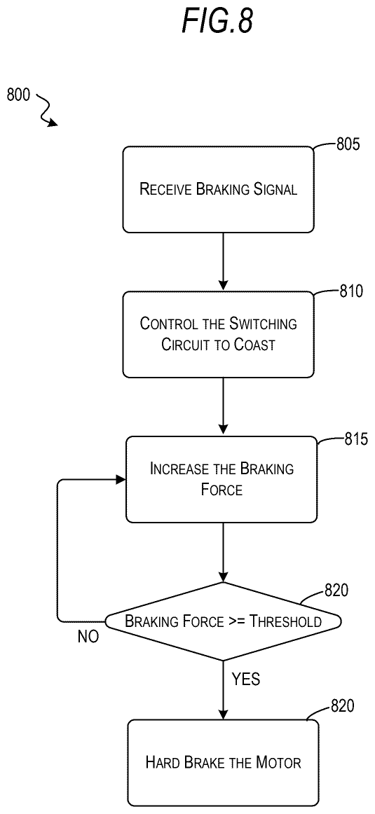

FIG. 7 is a graph 700 illustrating braking control as a function of time. FIG. 8 is a flow chart of a process 800 for implementing a soft braking to hard braking transition corresponding with the graph 700. At step 805 (corresponding with point 710), a user releases a trigger and the controller (e.g., controller 304) receives a signal to operate in a braking mode. At step 810, the controller 304 is configured to control the switching circuit 348 to coast the motor. As shown in FIG. 7, to coast the motor, the switching circuit 348 turns off the high-side switches and soft brakes the motor using one low-side switch at a minimum conduction angle and phase advance. In some embodiments, the motor is not coasted and soft braking is initiated following the release of the trigger. At step 810, after coasting the motor, the controller 304 controls the switching circuit 348 to periodically increase the braking force of the motor (i.e., during soft braking). For example, the controller 304 may provide a braking signal to the switching circuit 348 such that the conduction angle and/or the phase advance gradually increases by a fraction (e.g., 2%, 5%, 10%, etc.) of the maximum conduction angle and/or phase advance respectively. As shown in FIG. 7, the speed drop of the tool is parabolic, as the braking force linearly increases. At step 820, the controller 304 determines whether the braking force has met a predetermined threshold. In the example illustrated in the graph 700, the threshold is based on the maximum conduction angle and phase advance. Said another way, the controller 304 is configured to increase the conduction angle and phase advance of the signal used to brake the motor until the conduction angle reach their maximum values. In other embodiments, other criterion may additionally or alternatively be used to determine the threshold. For example, as shown in FIG. 9, the motor stops before the braking signal has reached a maximum conduction angle or phase advance angle. In the embodiment of FIG. 9, a speed threshold is used to initiate the switch from soft braking to hard braking. Once the speed of the motor has reduced or fallen to a speed threshold value (e.g., 3,000 rotations-per-minute [“RPM”], 5,000 RPM, 3,000 RPM to 5,000 RPM, etc.), hard braking is initiated even though the conduction angle and/or the phase advance angle have not reached their respective maximum values. Accordingly, the threshold may additionally or alternatively include the rotational speed of the motor. Lastly, upon reaching the threshold (corresponding to point 720), at step 825 the controller 304 operates the switching circuit 348 according to a hard braking method whereby each of the low-side switches are activated causing each of the U, V, and W motor phases to short circuit.

The process 800 allows for the power tool 100A, 100B to brake quickly with a low risk of overloading the components of the drive circuit. As described in greater detail below, in other embodiments, the increase in braking may not be linear and the periods between changing the commutation profile of the soft brake may not be regular. Additionally, the criterion to transition from soft braking to hard braking may include additional or alternative thresholds, such as a speed or energy of the motor.

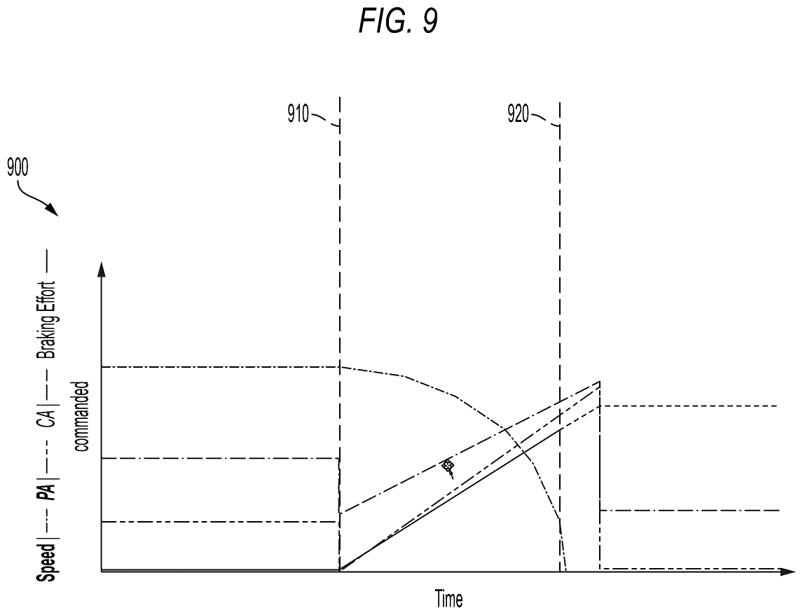

FIG. 10 illustrates a state machine or diagram implementing the process 800 in a power tool, such as power tool 100A, 100B. At the running state 1005, the controller 304 is configured to operate the switching circuit 348 to drive the motor (e.g., motor 115, 308). Upon releasing the trigger (e.g., trigger 320), the controller 304 is configured to control the switching circuit 348 to coast the motor. In the coasting state 1010, upon detecting a trigger pull, the controller 304 may control the motor according to the running state 1005. In some embodiments, the coasting state 1010 can be removed from the state diagram. In the running state 1005, the controller 304 may adjust the speed and power output by the motor according to a user input, such as the trigger. Upon detecting that the power tool 100A, 100B is not in use and minimal power is being drawn by the motor, the controller 304 may control the motor to operate in a brake state 1015. Once in the brake state 1015, the controller begins operating in a modulated brake state 1020 unless, for example, the trigger is pulled. It will be appreciated that the brake state 1015 can be a transitory state.

In the modulated brake state 1020, the controller 304 operates the switching circuit 348 such that the high-side switches are disabled, and the low-side switches are initially commutated with a conduction angle of 120 degrees and a phase advance angle of 0 degrees. The low-side switches are commutated such that no more than two low-side switches are short circuiting at a given time (i.e., soft braking). In the modulated brake state 1020, the controller 304 may increase (e.g., periodically, gradually, linearly, etc.) the conduction angle and/or the phase advance angle used to brake until, for example, a maximum conduction angle and/or a maximum phase advance angle is reached, until a back-EMF of the motor is less than a threshold value, until the speed of the motor has reached a speed threshold value, the speed of the motor is too slow to commutate, etc. In some embodiments, the speed threshold may be, for example, between 2,000 and 5,000 revolutions per minute.

Upon determining that a soft braking end condition has been satisfied, the controller may operate in a full brake state 1025. In the full brake state 1025, the controller 304 operates the switching circuit 348 using hard braking. Said another way, all three low-side switches are short circuited. Upon determining that the motor has stopped (e.g., using a position sensor), the controller 304 may operate in a stopped state 1030. In the stopped state 1030 the controller 304 is in a standby or idle mode until the trigger is pulled. In some embodiments, the controller 304 may maintain a hard brake in the stopped state 1030. In other embodiments, each of the plurality of switches may be disabled in the stopped state 1030. Upon detecting that the trigger was pulled, the controller 304 may transition from the stopped state 1030 to the coasting state 1010, where any hard braking is released.

Table 1 below illustrates the operating characteristics used in the state machine 1000.

TABLE 1

| | | Motor | Brake | | | Estimated |
|---|---|---|---|---|---|---|
| State | User Input | State | Controller | PA | CA | Braking Force |
| Running | Trigger Pulled | Powered | Inactive | Op | 120-Max | 0% |
| | | | | setpoint | OP | |
| Coasting | Trigger | Unpowered | Inactive | Op | 120° | <5% |
| | Released | (0% PWM) | | setpoint | | |
| Brake | Trigger | Braking | Active | 0° | 120° | Minimum |
| | Released | | | | | Braking % |
| Modulated | Trigger | Braking | Active | 0°-60° | 120°-240° | 0-99% |
| Brake | Released | (Modulated) | | | | |
| Full Brake | Trigger | Braking | Active | N/A | 360° | 100% |
| | Released | (Full) | | | | |
| Stopped | Trigger | Stopped | Inactive | N/A | N/A | N/A |
| | Released | | | | | |

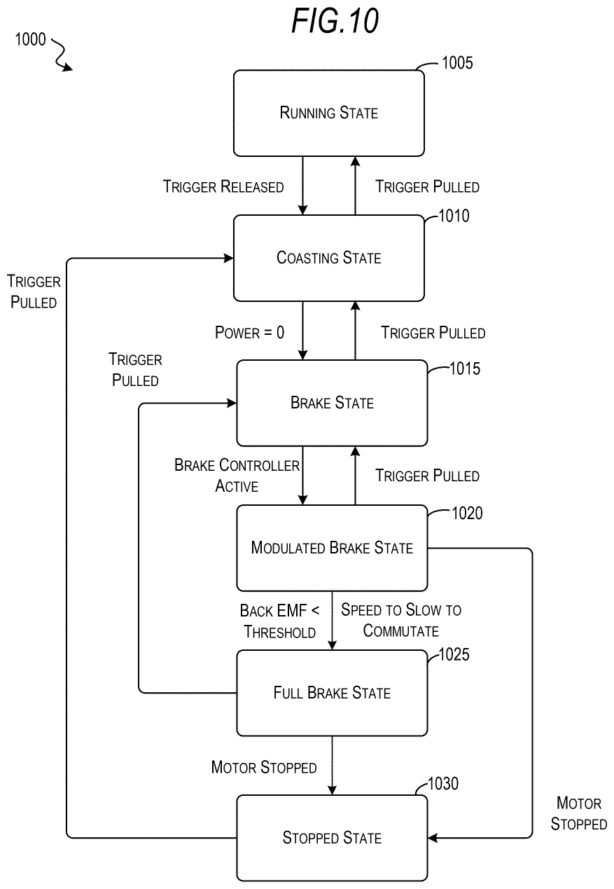

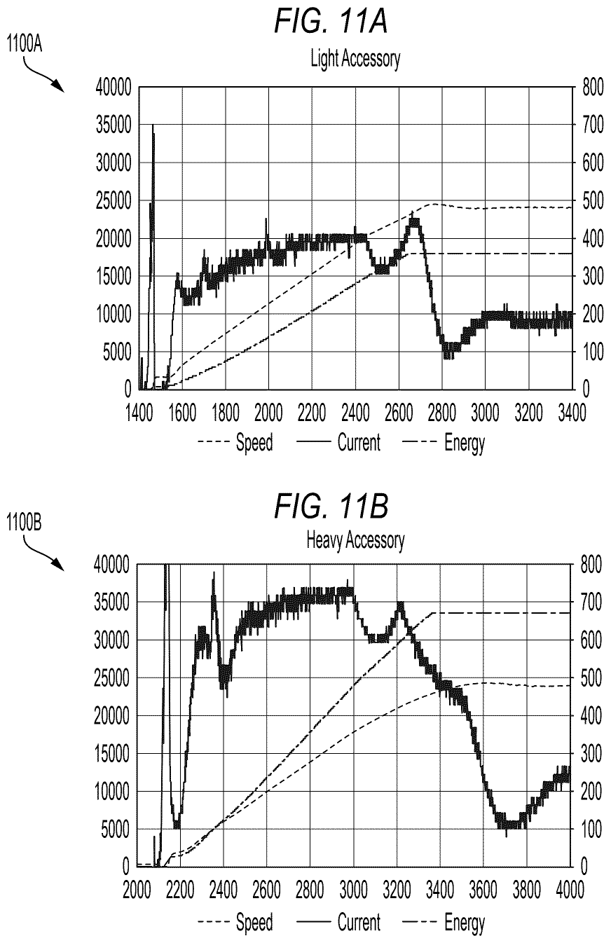

FIGS. 11A and 11B are graphs 1100A, 1100B illustrating the relationship between the energy of a tool, the speed of the tool, and the current drawn by the motor over a startup phase. The rotational energy of a tool can be approximated by multiplying the sum of the measured current or power (i.e., voltage multiplied by current) multiplied by the total time to startup. In some instances, the speed can also be used to approximate the rotational energy of a tool. However, as shown when comparing the speeds and rotational energies of graphs 1100A and 1100B, the speed does not account for moments of inertia resulting from the weight of an accessory attached to the power tool 100A, 100B. Despite having similar speed profiles, the calculated kinetic energy of the graph 1100B using measurements from a heavy accessory is much larger than the kinetic energy of the graph 1100A using measurements from a light accessory. Accordingly, in some embodiments the controller 304 may control the braking force applied to the motor 115, 308 based on the calculated kinetic energy determined during the startup of the tool. Based on the ability to control the braking force applied to the motor, it is possible to vary the time required to brake an accessory.

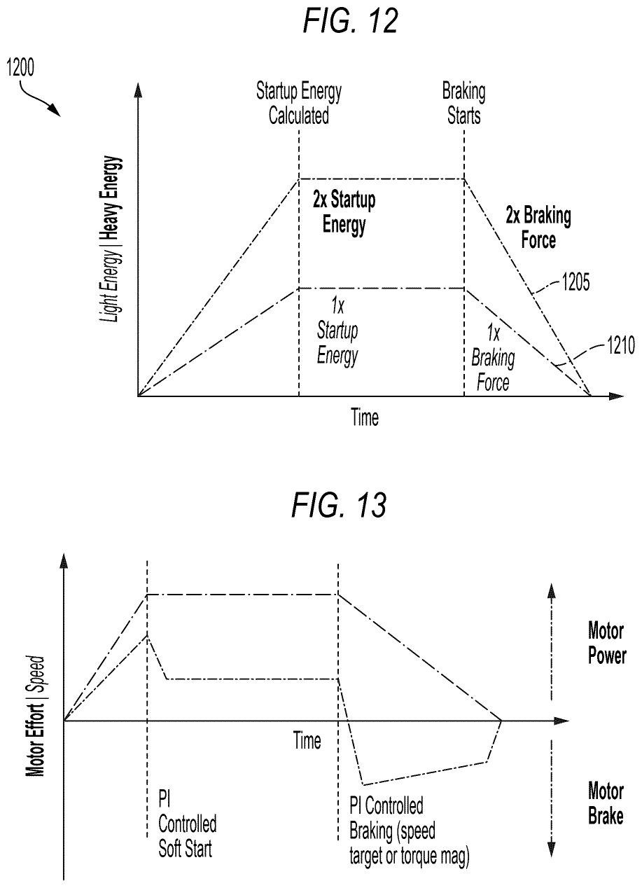

FIGS. 12 and 13 are graphs 1200, 1300 illustrating the kinetic energy of a power tool during a tool operation. Generally, upon activating the tool, the motor (e.g., motor 115, 308) increases in speed and draws power from a power source during a startup phase. After operation, the braking force output by the tool is adjusted based on the startup energy calculated during the startup phase. As shown in FIG. 12, based on the measured startup energy measured, the tool is operable to adjust the braking force such that both the heavy tool 1205 and the light tool 1210 stop rotating in approximately the same amount of time. In the illustrated embodiment of FIG. 12, the braking is modified by a percent difference from a baseline braking function. Said another way, because the heavy tool 1205 provided twice the amount of kinetic energy, the tool also increased the amount of braking applied. In some embodiments, the applied braking level may correspond with a value on look-up table. For example, the controller 304 may calculate a braking function between 0 and 10 based on the measured startup energy. Each value calculated by the controller 304 may correspond with a different commutation profile (e.g., coasting, hard braking, soft braking with a conduction angle of 140 degrees, etc.) and a different timing.

In the embodiment illustrated in FIG. 13, the operation and braking forces are controlled according to a closed-loop PI (Proportional Integral) control algorithm. In the illustrated embodiment, the setpoint is based on an energy calculated through an acceleration measurement. For example, during regular operation, the controller is configured to maintain an energy of the tool 100A, 100B at an operating speed (e.g., 10,000 RPM) and adjust the power provided to the motor to maintain the setpoint speed. In embodiments with adjustable braking, the PI controller may also incorporate speed control using variable braking. For example, when the setpoint speed is set to 0, the controller may additionally brake the motor according to one of the methods previously discussed.

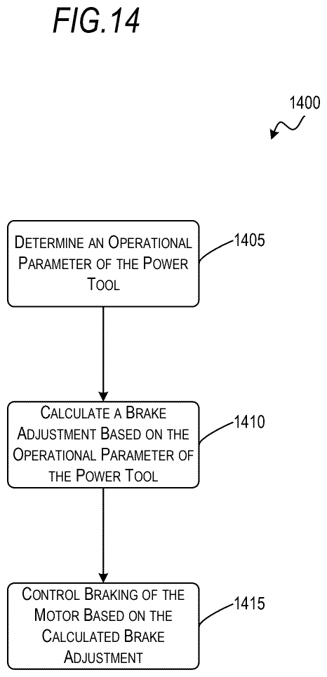

FIG. 14 is a flow chart illustrating a process 1400 of controlling a power tool during different operation phases. In step 1405, the controller 304 is configured to determine an operational parameter of the power tool during a startup phase. In some embodiments, the controller is operable to determine an energy level by measuring the startup energy or initial speed. After determining the operational parameter, in step 1410 the controller is configured to calculate a brake adjustment based on the operational parameter. In some embodiments, the controller 304 adjusts the commutation of the motor during braking to decrease the braking force applied. Additionally or alternatively, the controller 304 may not increase the braking force applied over time or the controller 304 may increase the period between when braking force is increased over time. One example of a calculated brake adjustment is a look-up table configured to provide the commutation profile (e.g., conduction angle and phase advance angle) corresponding with a required braking force output. In step 1415, the electronic controller 304 controls the switching circuit 348 based on the calculated commutation profile to control, during a braking phase, the commutation of the motor based on the calculated brake adjustment. In some embodiments, the commutation of the motor (e.g., the conduction angle and phase advance angle) increase as the required braking force increases. In some embodiments, the controller 304 may additionally or alternatively hard brake the motor.

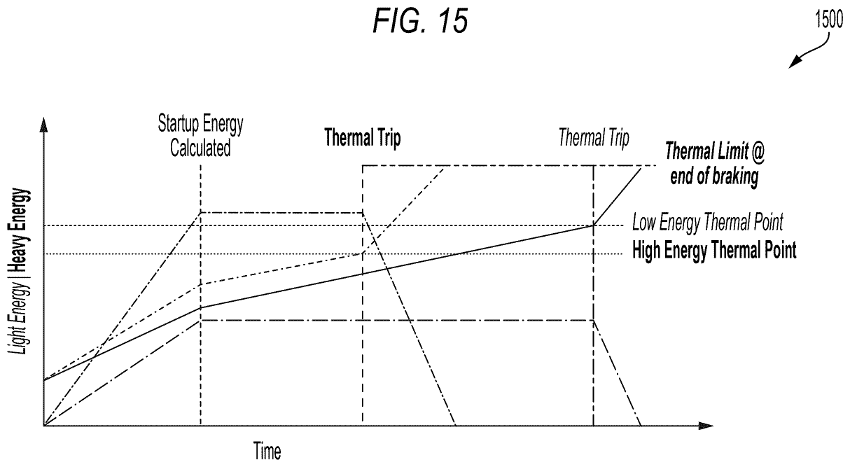

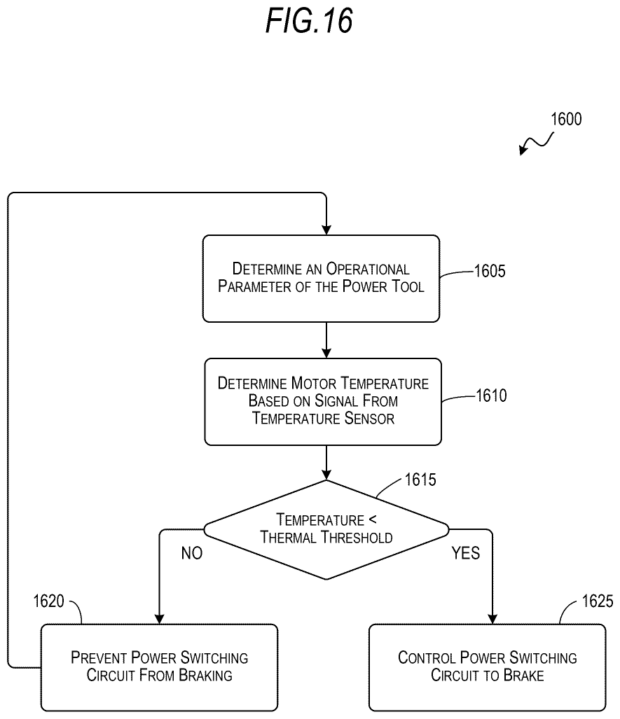

FIG. 15 illustrates a graph 1500 illustrating the energy level of the of the power tool 100A, 100B and a known thermal limit of the motor. The graph 1500 is similar to FIGS. 12 and 13, however, in addition to a determined startup energy level and corresponding brake force (in step 1605), the graph 1500 also includes a thermal energy cutoff point whereby the controller 304 may disable braking to prolong the lifetime of the tool. Accordingly, in the corresponding flowchart of FIG. 16 illustrating method 1600, in step 1610 the controller 304 receives a signal from a thermistor or other temperature sensor (e.g., temperature sensor 336) to determine a motor temperature based on the signal from the temperature sensor. Upon receiving the temperature signal, in step 1615 the controller 304 compares the temperature signal with a predetermined threshold temperature to determine if the motor is too hot to continue braking. As shown in FIG. 15, the threshold temperature may be a temperature below the thermal limit of the motor. The threshold temperatures can also be set based on the operational parameter of the power tool (e.g., startup energy) to set different limits for low energy startup and high energy startup power tools. Upon determining that the temperature of the motor is greater than or equal to the temperature threshold, in step 1620 the controller 304 prevents the power switching circuit 348 from braking. In some embodiments the controller 304 controls the power switching circuit to coast. Upon determining that the temperature of the motor is less than the temperature threshold, in step 1625 the controller 304 may control the power switching circuit 348 to brake the motor. In some embodiments, the motor may be braked according to a soft braking to hard braking transition method described herein. In other embodiments, the motor may be braked based on a determined braking force corresponding with the startup energy of the motor, the rotational energy of the motor, etc.

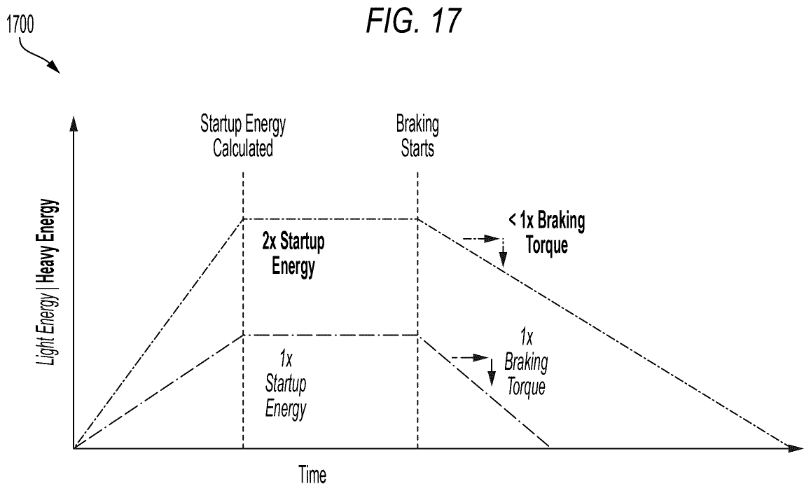

FIG. 17 illustrates a graph 1700 according to another embodiment of controlling braking according to the measured rotational energy of the motor. As shown in the graph 1700, upon the start of braking the slope of the heavy energy braking is lower than the slope of the light energy braking. The slope of the heavy energy tool has been decreased to slowly reduce the torque on the accessory. For the braking period of the light energy attachment, the motor can brake quickly with little risk of damage. Accordingly, it may be advantageous to group different startup energy levels based on a threshold and adjust the braking profile based on the group assignment.

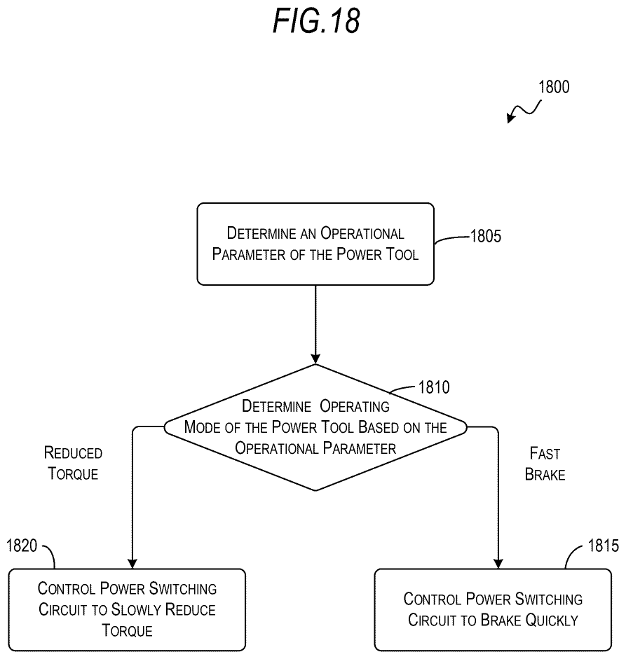

FIG. 18 is a flowchart illustrating a process 1800 for braking a power tool according to high energy and low energy groupings. During operation, at step 1805 the controller 304 is configured to determine an operational parameter of the tool. The operational parameter may include a temperature, a motor energy (e.g., startup energy), etc. Based on the operational parameter, at step 1810 the controller 304 is configured to determine a grouping of the tool. For example, in some embodiments the operational parameter is a motor energy (e.g., motor startup energy). If the motor energy is above a predetermined threshold, the controller 304 may brake in a reduced torque mode or a first brake configuration. Alternatively, if the motor energy is below the threshold, the controller 304 may brake in a fast brake mode or a second brake configuration. In the fast brake mode at step 1815, the electronic controller 304 is configured to control the power switching circuit to brake quickly. For example, the controller 304 may adjust the commutation of the motor during braking to increase the braking force applied, as described previously. In the reduced torque mode at step 1820, the electronic controller 304 is configured to control the power switching circuit 348 to slowly reduce the torque on the motor. In some embodiments, the controller 304 may adjust the commutation of the motor during braking to decrease the braking force applied. Additionally or alternatively, the controller 304 may not increase the braking force applied over time or the controller 304 may increase the period between when braking force is increased over time.

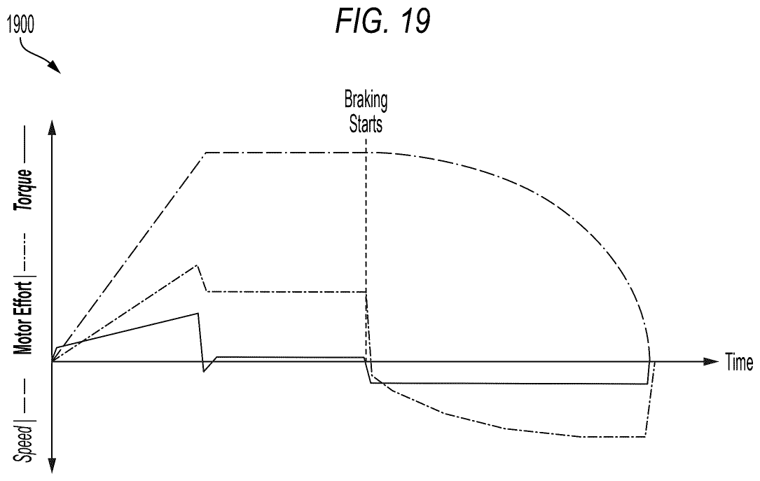

FIG. 19 illustrates another graph 1900 illustrating an embodiment for controlling braking. In the illustrated embodiment, the controller 304 may operate the motor to set a static braking torque instead of braking over a period of time. It will be appreciated that a minimum torque below the install torque for an accessory will allow for the tool 100A, 100B to retain the accessory. To control the motor according to the static torque embodiment, only one commutation profile (e.g., a static braking torque) is maintained throughout the braking cycle until the motor stops.

Thus, embodiments described herein provide, among other things, several methods and implementations of variable commutation braking. Various features and advantages are set forth in the following claims.

What is claimed is:

1. A power tool comprising:
a housing;
a motor within the housing;
a power switching circuit configured to control power provided from a power source to the motor; and
an electronic controller connected to the power switching circuit, the electronic controller configured to:
control the power switching circuit to apply a soft braking force,
control a conduction angle and a phase advance angle to increase the soft braking force, and
control, in response to the conduction angle reaching a maximum conduction angle and the phase advance angle reaching a maximum phase advance angle, the power switching circuit to apply a hard braking force.

2. The power tool of claim 1, wherein the power switching circuit includes a first high-side switch, a second high-side switch, a third high-side switch, a first low-side switch, a second low-side switch, and a third low-side switch.

3. The power tool of claim 2, wherein, to apply the soft braking force, the electronic controller is configured to control two of the first low-side switch, the second low-side switch, and the third low-side switch to be active.

4. The power tool of claim 2, wherein, to apply the soft braking force, the electronic controller is configured to control one of the first low-side switch, the second low-side switch, and the third low-side switch to be active.

5. The power tool of claim 1, wherein the maximum conduction angle is 180 degrees.

6. The power tool of claim 1, wherein the maximum conduction angle is 180 degrees to 240 degrees.

7. The power tool of claim 1, wherein the maximum phase advance angle is 60 degrees.

8. A power tool comprising:
a housing;
a motor within the housing;
a power switching circuit configured to control power provided from a power source to the motor; and
an electronic controller connected to the power switching circuit, the electronic controller configured to:
control the power switching circuit to apply a soft braking force,
monitor a speed of the motor,
control a conduction angle and a phase advance angle to increase the soft braking force, and
control, in response to the speed of the motor being reduced to a speed threshold value, the power switching circuit to apply a hard braking force.

9. The power tool of claim 8, wherein the power switching circuit includes a first high-side switch, a second high-side switch, a third high-side switch, a first low-side switch, a second low-side switch, and a third low-side switch.

10. The power tool of claim 9, wherein, to apply the soft braking force, the electronic controller is configured to control two of the first low-side switch, the second low-side switch, and the third low-side switch to be active.

11. The power tool of claim 9, wherein, to apply the soft braking force, the electronic controller is configured to control one of the first low-side switch, the second low-side switch, and the third low-side switch to be active.

12. The power tool of claim 8, wherein the speed threshold value is 3,000 rotations-per-minute to 5,000 rotations-per-minute.

13. The power tool of claim 9, wherein, to apply the hard braking force, the electronic controller is configured to control each of the first low-side switch, the second low-side switch, and the third low-side switch to be active.

14. The power tool of claim 8, wherein the power switching circuit to apply the hard braking force before the conduction angle has reached a maximum conduction angle and before the phase advance angle has reached a maximum phase advance angle.

15. A power tool comprising:
a housing;
a motor within the housing;
a power switching circuit configured to control power provided from a power source to the motor;
a sensor configured to measure an operational parameter of the power tool; and
an electronic controller connected to the sensor and the power switching circuit, the electronic controller configured to:
receive a signal from the sensor related to the operational parameter of the power tool,
determine, during a startup phase, the operational parameter of the power tool based on the signal from the sensor,
calculate a brake adjustment based on the operational parameter, and
control, during a braking phase, braking of the motor based on the brake adjustment.

16. The power tool of claim 15, wherein the electronic controller is further configured to:
control, in response to determining that the operational parameter is below a predetermined threshold, the power switching circuit to brake the motor according to a first braking configuration; and
control, in response to determining that the operational parameter is greater than or equal to the predetermined threshold, the power switching circuit to brake the motor according to a second braking configuration.

17. The power tool of claim 16, wherein:
the first braking configuration is a reduced torque mode; and
the second braking configuration is a fast brake mode.

18. The power tool of claim 15, wherein the operational parameter is one of a temperature, a motor energy, or a motor speed.

19. The power tool of claim 18, wherein the operational parameter is a startup energy of the motor during the startup phase.

20. The power tool of claim 15, wherein a braking force applied during the braking phase is set based on the operational parameter.
